(19) United States
(12) Patent Application Publication
(10) Pub. No.: US 2024/0256947 A1
(43) Pub. Date: Aug. 1, 2024

(54) CIRCULAR-BUFFER FOR GENERATING MACHINE LEARNING ESTIMATES OF STREAMING OBSERVATIONS IN REAL TIME

(71) Applicant: ORACLE INTERNATIONAL CORPORATION, Redwood Shores, CA (US)

(72) Inventors: Zejin DING, Atlanta, GA (US); Guang Chao WANG, San Diego, CA (US); Kenny C. GROSS, Escondido, CA (US)

(21) Appl. No.: 18/104,506

(22) Filed: Feb. 1, 2023

(51) Int. Cl. G06N 20/00

(52) U.S. Cl. CPC G06N 20/00

(57) ABSTRACT

Systems, methods, and other embodiments associated with generating a stream of ML estimates from a stream of observations in real-time using a circular double buffer are described. In an example method, observations are received from the stream of observations. The observations are loaded in real time into a circular buffer. The circular buffer includes a first buffer and a second buffer that are configured together in a circular configuration. Estimates of what the observations are expected to be are generated by a machine learning model from the observations that are in the circular buffer. The generation of estimates alternates between generating the estimates from observations in the first buffer in parallel with loading the second buffer, and generating the estimates from observations in the second buffer in parallel with loading the first buffer. The estimates are written to the stream of estimates in real time upon generation.

### BACKGROUND

Sensors for a wide variety of physical phenomena may be affixed to machines, devices, systems, or facilities (collectively referred to as “assets”). The sensors generate data about the physical phenomena occurring in or around an asset. The data produced by the sensors may be monitored or analyzed by computers.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments one element may be implemented as multiple elements or that multiple elements may be implemented as one element. In some embodiments, an element shown as an internal component of another element may be implemented as an external component and vice versa. Furthermore, elements may not be drawn to scale.

FIG. 1 illustrates one embodiment of a streaming ML estimation system associated with generating a stream of ML estimates from a stream of observations in real-time using a circular double buffer.

FIG. 2 illustrates one embodiment of a streaming ML estimation method associated with generating a stream of ML estimates from a stream of observations in real-time using a circular double buffer.

FIG. 3 illustrates a range chart of single-buffer operations and a range chart of circular-double-buffer operations using alternating pointers to switch between buffers.

FIG. 4 shows an example graph of total latency vs. number of signals for streaming ML anomaly detection with a single buffer processing configuration.

FIG. 5 shows an example graph of total latency vs. number of signals for streaming ML anomaly detection with a circular-double-buffer processing configuration.

FIG. 6 illustrates an embodiment of a computing system configured with the example systems and/or methods disclosed.

### DETAILED DESCRIPTION

Systems, methods, and other embodiments are described herein that provide for generating a stream of machine learning (ML) estimates from a stream of observations in real-time using a circular double buffer. In one embodiment, a streaming ML estimation system parallelizes input-output activity with ML estimation activity using a circular double buffer in order to reduce end-to-end latency. For example, the ML estimation system stores and draws observations from two opposite buffers that are connected together in a circular manner, enabling input/output latencies to be contemporaneous with (and hidden by) ML processing latency.

In one embodiment, the streaming ML estimation system receives an incoming stream of observations. The observations in the stream are placed into the circular buffer in real time as the observations are received. Estimates are generated from the observations in the circular buffer by an ML model. The ML model generates estimates of what the observations are expected to be. While the observations are being placed into the first buffer of the circular buffer, the ML model is generating estimates from the second buffer of the circular buffer, and while the observations are being placed into the second buffer of the circular buffer, the ML model is generating estimates from the first buffer of the circular buffer. The estimates are written to an output stream in real time as the estimates are generated. The stream of estimates may be used with the stream of observations to detect anomalies in the stream of observations.

No action or function described or claimed herein is performed by the human mind. An interpretation that any action or function can be performed in the human mind is inconsistent with and contrary to this disclosure.

### Definitions

As used herein, the terms “stream” and “streaming” refer to transmittal, use, and receipt of data as a steady, continual flow (for example, at a sampling rate), allowing use of portions of the data to occur while the data is being received.

As used herein, the term “real time” refers to substantially immediate operation that keeps pace with a throughput of a stream of data. In other words, a real time process happens within a maximum latency that does not cause the throughput of a stream of data to be reduced.

As used herein, the term “latency” refers to a delay or an amount of time taken to process and/or transmit data. As used herein, the term “end-to-end latency” refers to latency incurred from a beginning point of a process to an end point of a process. For example, an end-to-end latency may be from arrival of an observation at the streaming ML estimation system through writing an estimate for the observation to an output stream (as discussed below).

As used herein, the term “time series” refers to a data structure in which a series of data points (such as observations or sampled values) are indexed in time order. In one embodiment, the data points of a time series may be indexed with an index such as a time stamp and/or an observation number. As used herein, the terms “time series signal” and “time series” are synonymous.

As used herein, the term “vector” refers to a data structure that includes a set of data points (such as observations or sampled values) from multiple time series at one particular index such as a time stamp and/or observations number.

As used herein, the term “time series database” refers to a data structure that includes one or more time series that share an index (such as a series of time stamps, positions, or observation numbers) in common. As an example, time series may be considered “columns” of a time series database, and vectors may be considered “rows” of a time series database.

As used herein, the term “residual” refers to a difference between a value (such as a measured, observed, sampled, or resampled value) and an estimate, reference, or prediction of what the value is expected to be. In one embodiment, the residual is a positive or negative value. In another embodiment, the residual is an absolute value or magnitude. In one embodiment, a residual time series or time series of residuals refers to a time series made up of residual values between a time series of values and a time series of what the values are expected to be. And, in one embodiment, a residual vector or vector of residuals refers to a vector made up of residual values between a vector of values and a vector of what the values are expected to be.

### —Example Streaming ML Estimation System—

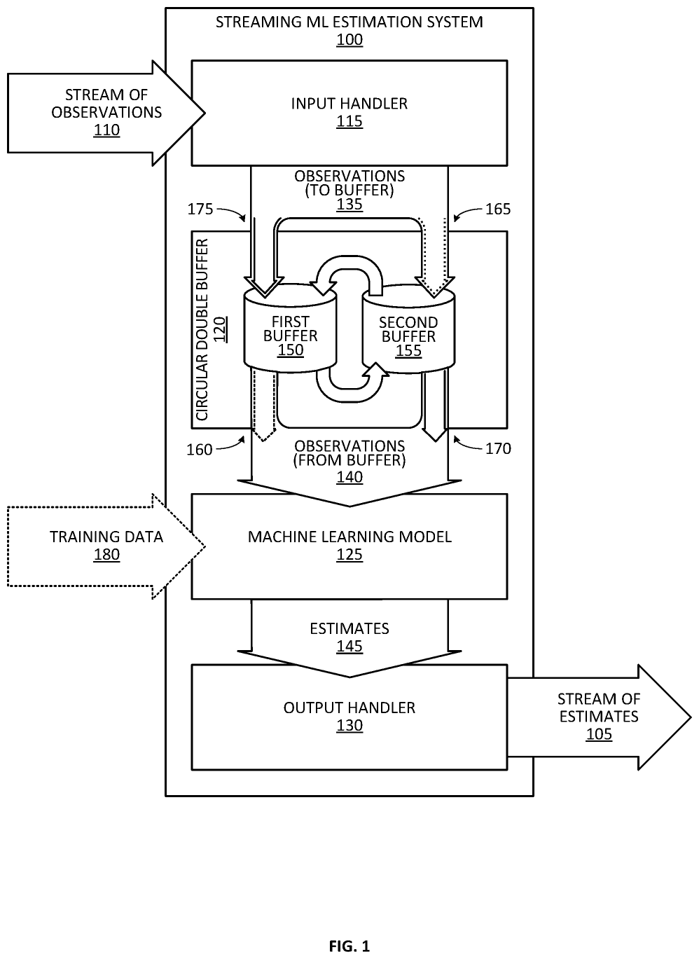

FIG. 1 illustrates one embodiment of a streaming ML estimation system 100 associated with generating a stream of ML estimates from a stream of observations in real-time using a circular double buffer. Streaming ML estimation system 100 includes components for generating a stream of estimates 105 from a stream of observations 110 in real time. The components of streaming ML estimation system 100 include an input handler 115, circular double buffer 120, a machine learning model 125, and an output handler 130. In one embodiment each of these components 115, 120, 125, and 130 of streaming ML estimation system 100 may be implemented as software executed by computer hardware. For example, components 110, 115, 120, 125, and 130 may be implemented as one or more intercommunicating software modules, routines, or services for performing the functions of the components.

Input handler 115 is configured to receive the stream of observations 110 as input and to load individual observations 135 received from the stream of observations 110 into circular double buffer 120. Circular double buffer 120 is configured to store observations 135 from input handler and serve observations 140 to machine learning model 125. Machine learning model 125 is configured to generate estimates 145 of what the observations 140 that are from the circular buffer are expected to be. Output handler 130 is configured to write estimates 145 as output to stream of estimates 105 in real time upon generation of the estimates 145.

Circular double buffer 120 includes a first buffer 150 and a second buffer 155 that are configured together in a circular configuration. The circular configuration of first buffer 150 and second buffer 155 links the buffers end-to-end in a loop. When one of the buffers 150, 155 becomes full, and a subsequent write operation is performed, the write is performed on the other of the buffers 150, 155, overwriting the oldest data. The generation of estimates 145 by machine learning model 125 alternates between generating the estimates 145 from the observations 140 that are in the first buffer 150 (as indicated at reference 160) in parallel while (or contemporaneously with) the second buffer 155 is being loaded (as indicated at reference 165), and generating the estimates 145 from the observations 140 that are in the second buffer 155 (as indicated at reference 170) in parallel while (or contemporaneously with) the first buffer 150 is being loaded (as indicated at reference 175).

In one embodiment, machine learning model 125 is configured to accept training data 180, a series of observations that are representative of normal, nominal, or typical measured values for the observations. Machine learning model 125 is configured to perform an initial training operation to adjust machine learning model 125 to produce estimates consistent with training data 180.

In one embodiment, machine learning model 125 is executed by a primary compute instance, and input handler 115 and output handler 130 are executed by an ancillary compute instance. The circular buffer 120, including first buffer 150 and second buffer 155, is in a memory or storage location that is accessible to both the primary compute instance and the ancillary compute instance.

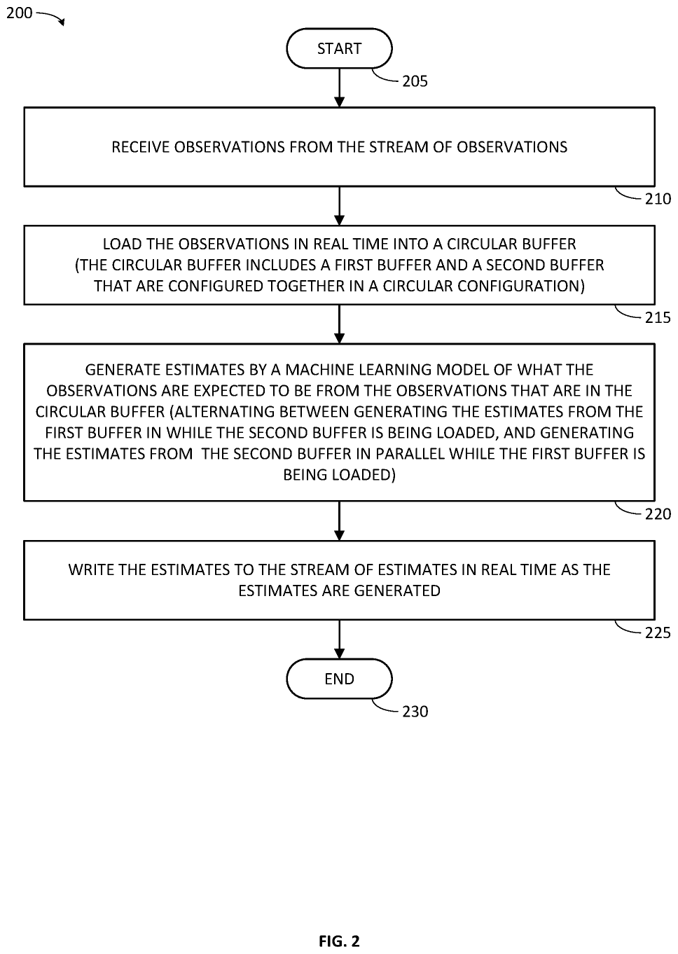

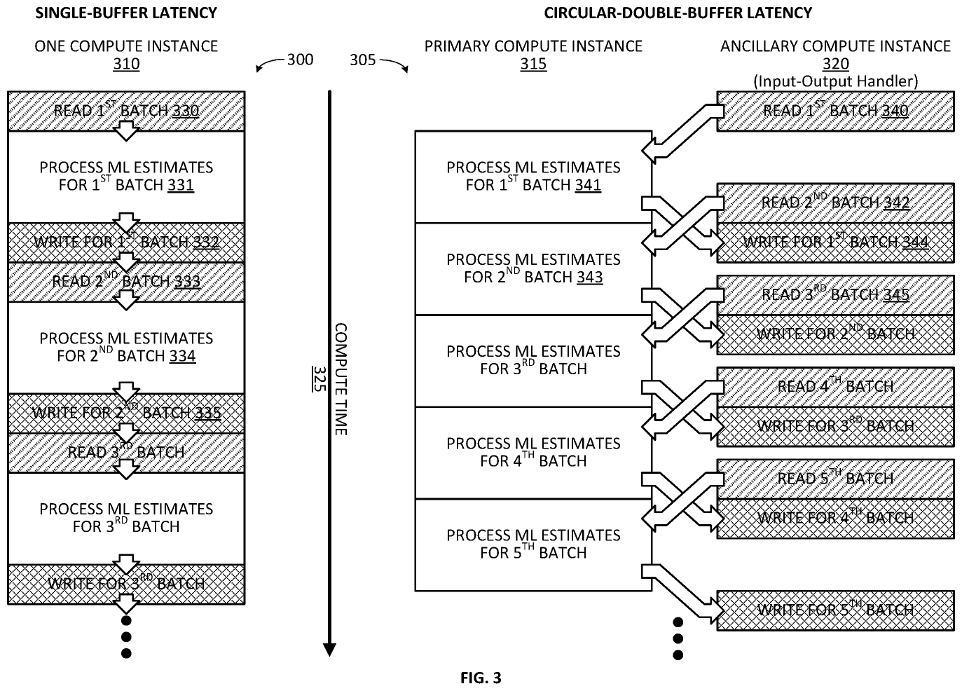

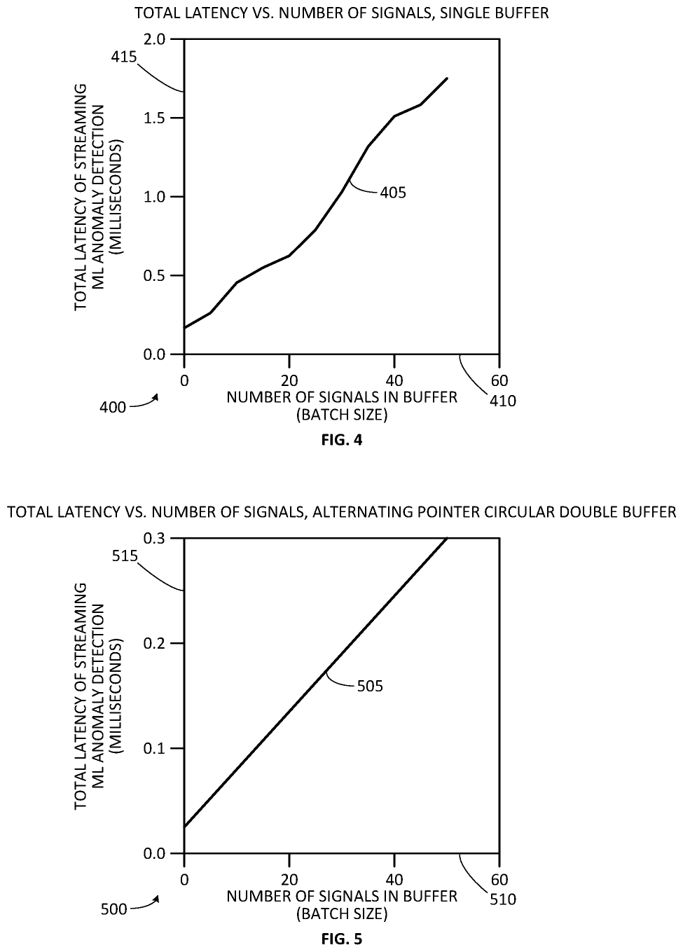

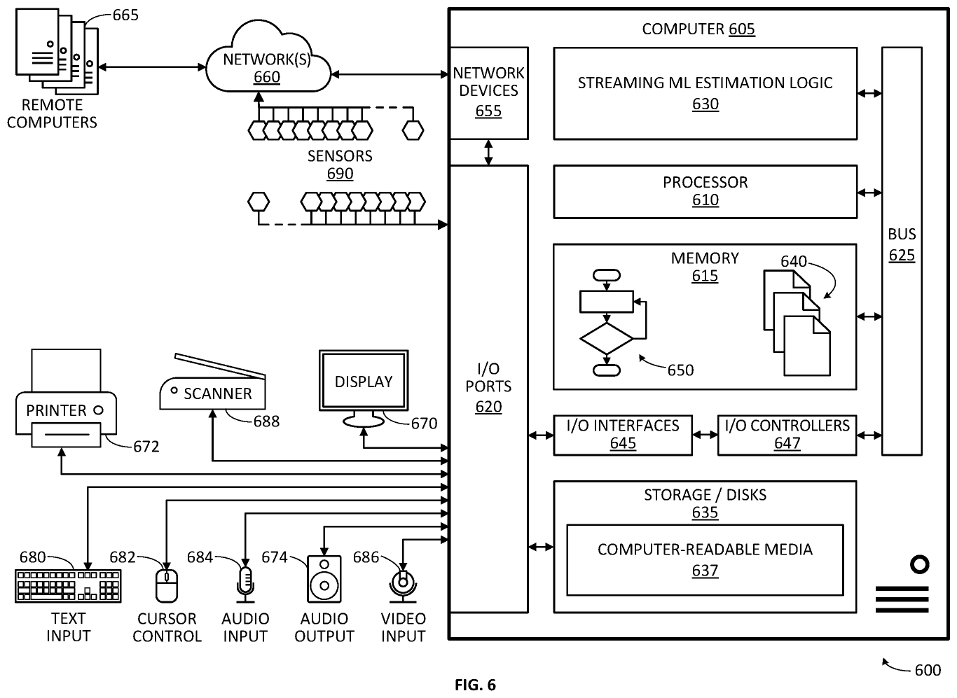

In one embodiment, streaming ML estimation system 100 implements a circular double buffer architecture for parallelized ML estimation and input/output handling. Further details regarding streaming ML estimation system 100 are presented herein below. In one embodiment, the operation of streaming ML estimation system 100 will be described with reference to example streaming ML estimation method 200 shown in FIG. 2. In one embodiment, the latency incurred by the operation of streaming ML estimation system 100 will be described with reference to range charts 300, 305 of latency decomposition shown in FIG. 3, and with reference to graphs 400 and 500 shown in FIGS. 4 and 5, respectively.

### —Example Streaming ML Estimation Method—

FIG. 2 illustrates one embodiment of a streaming ML estimation method 200 associated with generating a stream of ML estimates from a stream of observations in real-time using a circular double buffer. As an overview, in one embodiment, streaming ML estimation method 200 receives observations from the stream of observations. Streaming ML estimation method 200 loads the observations in real time into a circular buffer. The circular buffer includes a first buffer and a second buffer that are configured together in a circular configuration. Streaming ML estimation method 200 generates estimates by a machine learning model of what the observations are expected to be from the observations that are in the circular buffer. The generation of estimates alternates between generating the estimates from the observations that are in the first buffer in parallel while the second buffer is being loaded, and generating the estimates from the observations that are in the second buffer in parallel while the first buffer is being loaded. Streaming ML estimation method 200 writes the estimates to the stream of estimates in real time as the estimates are generated.

In one embodiment, streaming ML estimation method 200 initiates at START block 205 in response to a streaming ML estimation system determining one or more of (i) an incoming stream of observations has been detected; (ii) that an instruction to perform streaming ML estimation method 200 on a stream of observations has been received (iii) a user or administrator of streaming ML estimation system 100 has initiated streaming ML estimation method 200; (iv) it is currently a time at which streaming ML estimation method 200 is scheduled to be run; or (v) that streaming ML estimation method 200 should commence in response to occurrence of some other condition. In one embodiment, a computer configured by computer-executable instructions to execute functions of streaming ML estimation system 100 executes streaming ML estimation method 200. In one embodiment, the steps of streaming ML estimation method 200 or other methods herein are performed as a streaming workflow that processes observations as they arrive. Following initiation at start block 205, streaming ML estimation method 200 continues to process block 210.

### —Example Streaming ML Estimation Method-Receiving Observations—

At process block 210, streaming ML estimation method 200 receives observations from a stream of observations. The observations arrive as a stream of inputs to the streaming ML estimation method 200. The observations arrive separated by intervals, such as the intervals of a sampling rate.

In one embodiment, the observations are vectors that include multiple observed values at a particular time stamp. For example, there may be an observed value for each signal in a set of time series signals. In other words, the stream of observations may be a stream of vectors that make up a time series database. In one embodiment, the observations are produced by sensors. Thus, in one embodiment the observations are vectors that include an observed value for each sensor in a set of sensors. In one embodiment, streaming ML estimation method 200 receives a stream of vectors of observed values from a set of sensors. Thus, for example, the stream of observations are a sequence of vectors in a time series database of sensor readings.

In one embodiment, streaming ML estimation system 100 listens to or is subscribed to the stream of observations. Streaming ML estimation system 100 detects the arrival observations from the stream. In response to detection of the arrival of an observation, streaming ML estimation system 100 ingests or accepts the observation. Streaming ML estimation system 100 places the observation into memory to retain the observation for subsequent storage, for example storage in circular double buffer 120. Receiving observations may repeat indefinitely while observations continue to arrive from the stream of observations. Receiving observations is performed in real time so as to retain the observation from the stream in memory before it is replaced in the stream by a subsequent observation.

Process block 210 then completes, and streaming ML estimation method 200 continues at process block 215. At the completion of process block 210, the most recently arrived observation from the stream has been ingested and retained in memory for subsequent storage.

### —Example Streaming ML Estimation Method-Loading the Circular Buffer—

At process block 215, streaming ML estimation method 200 loads the observations in real time into a circular buffer. The circular buffer includes a first buffer and a second buffer that are configured together in a circular configuration. The circular buffer made up of a first buffer and a second buffer configured together in a circular configuration may be referred to herein as a circular double buffer.

Generally, a buffer is a region of memory used for temporarily collecting information in advance of processing. For example, a buffer is a data structure. In one embodiment, a buffer includes storage positions for a number of observations. A circular buffer is a form of buffer in which, when the buffer is full and a subsequent write is performed, the buffer continues to add data by overwriting the oldest data. In one embodiment, the circular buffer is a composite buffer made up of two individual buffers (a first buffer, and a second buffer) configured together in a circular configuration. The first buffer and second buffer are connected end-to-end in a circular arrangement. In one embodiment, in the circular arrangement of the two individual buffers, when one buffer of the two buffers is full and a subsequent write is performed, the data is added to the other buffer of the two buffers by overwriting the oldest data in the other buffer. In one example, this composite arrangement of two buffers as a circular buffer may be referred to herein as a circular double buffer.

In one embodiment, the first and second buffers that make up the circular double buffer may also be considered to be “circular” in that old data is overwritten by new data after the buffer becomes full. But, data in these two individual buffers is not immediately overwritten when the end of the buffer is reached. Instead, the writing is transferred to the other buffer when the end is reached, and the buffer that was just filled is read by the ML model to generate estimates.

In one embodiment, streaming ML estimation method 200 places observations newly received from the stream of observations alternately into one of two buffers. In one embodiment, streaming ML estimation method 200 switches placing vectors of observations between the two buffers when the one of the two buffers becomes full. In particular, filling or loading of the buffer is swapped between the buffers when one of the buffers that is currently being filled becomes full. For example, streaming ML estimation method 200 alternates between placing the observations arriving from the input stream of observations into a first buffer until the first buffer is filled and placing the observations arriving from the input stream of observations into a second buffer until the second buffer is filled. In other words, streaming ML estimation method 200 switches between buffers in response to the buffer currently receiving newly-received observations becoming full. Thus, a first subset of the incoming observations are temporarily stored in the first buffer, and a second subset of the incoming observations are temporarily stored in the second buffer.

A buffer becomes full or is filled when a number of observations that is equal to the length of the buffer (or the size of a batch, as discussed below) have been placed into the buffer. In other words, a buffer becomes full when an observation is written into a final available position in the buffer. When a buffer becomes full, a complete batch of observations for generation of ML estimates has been gathered in the buffer. In one embodiment, streaming ML estimation method 200 continues loading the observations into a first circular buffer until the first circular buffer is full, and into a second circular buffer until the second circular buffer is full indefinitely in a repeated cycle while the streaming ML estimation system continues to receive observations from the stream of observations. Thus, the ML model is provided with a continual sequence of complete batches of observations for processing, thereby removing the input latency for gathering the batch for all batches except the first batch.

In one embodiment, an intake pointer indicates which of the two buffers that incoming observations are being loaded into. The intake pointer alternates between pointing to the first buffer and the second buffer. The intake pointer points to opposite of an outflow pointer (discussed in process block 215 below) that indicates which buffer is being read by the ML model. In one embodiment, the intake pointer is or includes a variable that stores an address in memory of one of the two buffers. The intake pointer may be updated to indicate (that is, store the address in memory of) the first buffer in response to the final position of the second buffer being filled, and the intake pointer may be updated to indicate the second buffer in response to the final position of the first buffer being filled.

Each of the two individual buffers that make up the circular double buffer have a buffer length that accommodates a batch of observations for processing. This buffer length may also be referred to as a batch size. In one embodiment, first and second buffers share a buffer length in common, that is, both of the two individual buffers are of the same length. Thus, in one embodiment, the first buffer (of buffer length R positions) and second buffer (also of buffer length R positions) are configured together to be a circular double buffer (of length 2R positions). The observations are placed into an individual buffer in time order of receipt from the stream of observations. When full, an individual buffer contains a batch of observations arranged in time order for processing by the ML model.

The observations may be indexed with a time stamp. The observations may be vectors of observed values for a collection of signals at a time stamp. The batch of observations are thus a time series of observations. The individual buffers therefor each have a length of the batch size, and a width of the number of signals. The observations may be considered “rows” in a buffer, and the signals may be considered “columns” of the buffer. When full, the first and second buffers may each be considered a batch-length segment of a time series database that is being delivered by the stream of observations.

In one example, the time stamp may indicate a time at which the observation was taken from sensors, and the time stamp may be included in the data structure for the observation arriving from the stream of observations. Or, in another example, the time stamp may indicate a time at which the observation arrived from the stream. As discussed elsewhere herein, the observations may be vectors of observed values for a collection of signals at a time stamp. In one embodiment, both of the first and the buffers discussed herein will contain a batch of time series data for processing.

In one embodiment, loading an observation into a circular double buffer involves placing or writing the observation into a next available position in the circular double buffer. In one embodiment, the observation is written to the next available position, and a pointer or other indicator of the next available position is advanced by one position. In one embodiment, loading an observation into the circular double buffer in real time causes the observation to be placed or written into the circular double buffer promptly in response to the observation being received. For example, loading the observation in real time is completed with a maximum delay that permits loading of observations that arrive at the sampling rate of the stream of observations.

In one embodiment, receiving observations from a stream of observations and loading the observations in real time into a circular double buffer are performed by an input handler, such as input handler 115. The input handler is configured to perform one or more functions described with reference to process block 210 and 215. In one embodiment, receiving observations from a stream of observations and loading the observations in real time into a circular double buffer are performed by an ancillary compute instance. The ancillary compute instance may be executed in parallel with a primary compute instance that is configured to generate ML estimates, as described below. Thus, in one embodiment, receiving and loading observations into one buffer occurs in parallel with or concurrently with generation of ML estimates from another buffer.

In one embodiment, loads the observations in real time into a circular double buffer that is made up of a first and second buffer configured end-to-end by writing each observation into the next available position in the circular double buffer in response to the observation being received, and switching between writing to next available positions in one of the first and second buffers and writing to next available positions in the other of the first and second buffers in response to a final available position in the one buffer being loaded with an observation. Process block 215 then completes, and streaming ML estimation method 200 continues at process block 220. At the conclusion of process block 215, batch-sized buffers are filled with observations for subsequent processing to generate ML estimates. In this way, streaming ML estimation method 200 converts the stream of observations into sequential batches for subsequent batch-wise generation of estimates.

### —Example Streaming ML Estimation Method-Generating Estimates—

At process block 215, streaming ML estimation method 200 generates estimates by a machine learning model of what the observations are expected to be from the observations that are in the circular double buffer. The generation of estimates alternates between generating the estimates from the observations that are in the first buffer in parallel while the second buffer is being loaded, and generating the estimates from the observations that are in the second buffer in parallel while the first buffer is being loaded.

Recall that an observation is a vector of observed values for each signal of a set of signals, and that an estimate is a vector of estimated values for each signal in the set of signals. In one embodiment, the machine learning model is configured to execute a function that outputs an estimated value for each observed value in an observation based on other observed values in the observation. The other observed values are observed values for signals other than the signal for which the estimated value is being generated. The ML model retrieves the observation, for example by reading the observation from one of the first or second buffers in the circular double buffer. The ML model reads the observed values as parameters for the function. The ML model then executes the function to produce an estimated value for each signal from the observed values for the other signals. The ML model writes an estimated value for each signal into a position for the signal in a vector of estimated values. In one embodiment, the estimated values thus generated by the ML model may be produced as an estimate data structure-a vector of estimated values for each signal in a set of signals.

The estimates represent what the observations are expected to be, provided that the behavior reported by the signals is normal behavior. An estimated value for each signal is a value that is appropriate or within an expected range, given the observed values for other signals. Where estimated value and observed value of a signal are sufficiently different (that is, have a large residual), the signals may be reporting abnormal behavior of a monitored asset.

In one embodiment, the ML model is trained to generate estimates of what the observations are expected to be based on training observations that represent a normal operation. The ML model is trained or configured to produce estimates that are what the observations are expected to be, based on the observations that are in the circular double buffer. To train the machine learning model, a supervised learning process is executed on the machine learning model and training data. The training data may be a set or series of observations in which the observed values for signals at each observation are stipulated to be normal, nominal, or typical measured values given the other signal values at the observation. The observations in the training set represent normal operation of a monitored asset in which the monitored asset is functioning within appropriate or expected parameters. The observations in the training set may be live data streamed from the stream of observations. The observations in the training set may also be from a historical database of time series signals.

In the supervised learning process, parameters of the function of the ML model are iteratively adjusted toward producing estimated values that approximate observed values in the training data. The supervised learning process concludes once the ML model consistently produces estimated values that are sufficiently similar to the observed values in the training data. The trained ML model may then be used to produce estimates from the observations that are received from the stream of observations.

In one embodiment, the machine learning model is implemented as one or more non-linear non-parametric (NLNP) regression algorithms used for multivariate pattern recognition or anomaly detection. These ML anomaly detection algorithms may include neural networks (such as long short-term memory (LSTM) networks), support vector machines (SVMs), auto-associative kernel regression (AAKR), and similarity-based modeling (SBM) such as the multivariate state estimation technique (MSET). Thus, in one embodiment, the ML model is a NLNP model or an MSET model. And, in one embodiment, the ML model is a multivariate machine learning model that operates on inputs of a set of multiple variables to produce estimates for the multiple variables.

In one embodiment, the ML model generates estimates of what the observations are expected to be from the observations that are in the first buffer while the second buffer is being loaded from a real-time stream of observations. And, the ML model generates estimates of what the observations are expected to be from the observations that are in the second buffer while the first buffer is being loaded from the real-time stream of observations. In one embodiment, reading or retrieval of estimates from alternate sources (the first and second buffers) in the circular double buffer recurs in a repeated cycle in response to a continuing arrival of new observations from the stream of observations. In this manner, streaming ML estimation method 200 generates estimates with the ML model from the observations from one of the two buffers concurrently while an other of the two buffers is being loaded with the observations from the stream of observations.

For the two individual buffers (the first buffer and second buffer) that make up the circular double buffer, a read operation that retrieves observations from a buffer to the ML model for processing is transferred to a buffer when the buffer becomes full. In one embodiment, an outflow pointer indicates which of the two buffers a batch of observations is being read from for processing. The outflow buffer indicates which buffer is the source from which the ML model is drawing observations to produce estimates. The outflow pointer alternates between pointing to the first buffer and the second buffer. The outflow pointer points to opposite of intake pointer. indicates source buffer. In one embodiment, the outflow pointer is or includes a variable that stores an address in memory of one of the two buffers. In one embodiment, the outflow pointer switches between buffers in response to same events as the intake pointer (discussed with reference to process block 215 above. The outflow pointer may be updated to indicate (that is, store the address in memory of) the first buffer in response to the final position of the first buffer being filled, and the outflow pointer may be updated to indicate the second buffer in response to the final position of the second buffer being filled.

In one embodiment, streaming ML estimation method 200 generates estimates from the observations in the two buffers (the first and second buffers of the circular double buffer) by a machine learning model that is executed by a primary compute instance. And, streaming ML estimation method 200 loads the observations into the two buffers with an ancillary compute instance. The primary and ancillary compute instances may be, for example, discrete virtual machine (VM) instances, or discrete cloud containers. The two compute instances share access to memory and/or storage. The circular double buffer is stored in the memory that both compute instances can access.

In one embodiment, the primary and ancillary compute instances both operate a machine learning application. The machine learning application includes functions including functions for executing the machine learning model to produce estimates, functions for loading the observations from the stream of observations into the circular double buffer and functions for writing the estimates generated by the ML model to an output stream of estimates. In one embodiment, the primary compute instance executes the functions of the machine learning application that cause the machine learning model to produce estimates. In one embodiment, the ancillary compute instance executes the functions of the machine learning application that cause the observations to be loaded into the circular double buffer and the functions of the machine learning application that cause the estimates (and associated data such as observations and residuals corresponding to the estimates) to be written to the output stream. In one embodiment, the ancillary compute instance may be also referred to herein as an input-output handler.

In one embodiment, streaming ML estimation method 200 generates first estimates (first vectors of estimated values) from the observations (vectors of observed values) in the first buffer (of the circular double buffer) by a multivariate machine learning model. And, streaming ML estimation method 200 generates second estimates (second vectors of estimated values) from the observations (vectors of observed values) in the second buffer (of the circular double buffer) by the multivariate machine learning model. In one embodiment, the ancillary compute instance performs the loading of observations from the stream into the first and second buffers to produce a batch of observations for processing while the primary compute instance contemporaneously, in parallel, produces ML estimates from a previously loaded batch. In one embodiment, the previously loaded batch was loaded into one buffer immediately prior to the loading of an other buffer that is currently being loaded.

In one embodiment, the streaming ML estimation method 200 switches which of the two buffers in the circular double buffer is being loaded, and which is being processed, in response to the buffer that is currently being loaded becoming full. For example, in parallel with the generation of first estimates by the machine learning model, streaming ML estimation method 200 places the observations from the stream into the second buffer until the second buffer is filled. In response to the second buffer being filled, streaming ML estimation method 200 generates the second estimates from the observations in the second buffer by the machine learning model. In parallel with the generation of the second estimates by the machine learning model, streaming ML estimation method 200 places the observations from the stream into the first buffer until the first buffer is filled. In response to the first buffer being filled, streaming ML estimation method 200 generates first estimates from the observations in the first buffer by a machine learning model.

In one embodiment, this cycle repeats indefinitely while new observations received from the stream of observations have not had estimates generated. The ML model rotates or alternates between drawing observations for estimation from the first buffer and second buffer in the circular double buffer. The between drawing first batch of observations from the first buffer while the second buffer is being loaded, and drawing second batch of observations from the second buffer while the first buffer is being loaded. Thus, while the buffer that is currently being filled has not become full, streaming ML estimation method 200 generating first vectors of estimates from the vectors of observations in the buffer that is not currently being filled using a machine learning model.

In one embodiment, using the ancillary compute instance to fill the buffer that is currently being filled and output estimates is performed in parallel with using the primary compute instance to generate the estimates from the vectors of observations in the buffer that is not currently being filled. In one embodiment, the circular double buffer thus enables input-output operations to be performed in parallel with generation of estimates. Processing latency is thus reduced.

Thus, in one embodiment, streaming ML estimation method 200 generates estimates from the observation data from one buffer (of the circular buffer) that has previously been loaded in parallel (concurrently) while the other buffer (of the circular buffer) is being loaded with observations from the stream of observations, and then alternates between the two buffers based on which buffer is currently being loaded. Process block 220 then completes, and streaming ML estimation method 200 continues at process block 225. At the conclusion of process block 220, ML estimates of what observations ought to be have been produced for a previously loaded batch of observations in parallel while another batch of observations was being loaded. The ML estimates may be written to an output stream of estimates.

### —Example Streaming ML Estimation Method-Writing Estimates to Stream—

At process block 225, streaming ML estimation method 200 writes the estimates to the stream of estimates in real time as the estimates are generated. In one embodiment, the estimates generated by the ML model are streamed out upon generation.

As discussed above, in one embodiment the estimate is a data structure that includes a vector of estimated values for a set of signals and a time stamp or other index. In one embodiment, the estimate may also include other data in the data structure. In one embodiment, the estimate may include both the vector of estimated values for the set of signals and a vector of the corresponding observed values for the set of signals, thus including both the observation and estimate together. In one embodiment, the estimate may include both the vector of estimated values for the set of signals and a vector of the corresponding residual values for the set of signals, thus including both the estimate and residuals from the observation together. In one embodiment, the estimate may include the vector of estimated values for the set of signals, the vector of corresponding observed signals for the set of signals, and the vector of the corresponding residual values for the set of signals. “Corresponding” estimated values, observed values, and residuals correspond with regard to time stamp or other index.

In one embodiment, the stream of estimates is defined by a streaming function that streams data values. The streaming function monitors a particular location in memory that is used for output of estimates by the ML model. Upon generation by streaming ML estimation method 200, estimate data structures generated at process block 220 are placed into the location in memory monitored by the streaming function. The streaming function detects the writing of an estimate to the location in memory. In response to detecting the writing of the estimate into the location in memory, the streaming function retrieves the estimate and then transmits the estimate to a destination. The destination may include, for example, a location in memory or storage, another program or function, or a network location. For example, the destination may be an anomaly detection test program or function for determining if residuals between observation and estimate are anomalous (for example as discussed below).

In one embodiment, the estimates are written to the stream one estimate at a time. The estimates are written in real time. In one embodiment, real-time writing of the estimate to the stream of estimated does not wait for one or more subsequent estimates to be generated before commencing to write the estimate to the stream. Instead, for example, the estimates are written to the output stream promptly upon generation of the estimate and in response to generation of the estimate.

In one embodiment, the estimates are written to the stream by the ancillary compute instance. In one embodiment, the estimates are written to the stream by the ancillary compute instance in parallel with ML estimate generation by the primary compute instance. For example, streaming ML estimation method 200 writes the estimates to the output stream of estimates using the ancillary compute instance. In one embodiment, the ancillary compute instance writes the estimates that are generated while the primary compute instance generates subsequent estimates from observations stored in the circular double buffer. The ancillary compute instance writes an estimate that has been generated by the primary compute instance while the primary compute instance is contemporaneously generating a subsequent estimate. Because the writing of the estimate to the stream is handled contemporaneously, in parallel with the generation of later estimates, write latency for output to the stream hidden by the compute latency of the estimate generation. End-to-end latency is thereby further reduced.

In one embodiment, streaming ML estimation method 200 monitors the output of the ML model for the generation of estimates; then, upon detection of a generation of an estimate by the ML model, the estimate is promptly retrieved and transmitted to a destination (such as a downstream anomaly detection test function or program) while the ML model is operating to produce a subsequent estimate. Process block 225 then completes, and streaming ML estimation method 200 continues to end block 230, where method 200 completes.

At the completion of streaming ML estimation method 200, ML estimates of observations received from a stream have been produced and streamed out, in real time, in a manner that reduces end-to-end latency taken by the streaming ML estimation process. Due to the steps described herein for use of a circular-double-buffer, streaming ML estimation method 200 produces estimates in a stream with only minimal latency consumed by input and output operations, and where the majority of the latency is due to the actual generation of the ML estimates. In one embodiment, this enables even earlier detection and alerting when anomalies occur than in other methods for streaming generation of estimates.

### —Further Embodiments of Streaming ML Estimation Method—

In one embodiment, before initiating the parallelized processing of ML estimation and input-output activities (using the circular double buffer arrangement of the first and second buffers) discussed above, the method determines whether serial processing of input, ML estimation, and output is too slow. Thus, in one embodiment, before, loading the observations in real time into a circular buffer, the end-to-end latency for serial processing of the observations into estimates is measured and, if the end-to-end latency for serial processing is too high, processing switches to the parallelized processing.

In one embodiment, before loading the observations in real time into a circular buffer, streaming ML estimation method 200 additionally measures an end-to-end latency for serially loading the observations, generating the estimates from the observations, and writing the estimates to the stream of estimates. Then, the streaming ML estimation method 200 compares the end-to-end latency to a threshold for a maximum acceptable latency. Then, streaming ML estimation method 200 switches to loading the observations into the circular buffer in response to satisfying the threshold.

Where the threshold is satisfied (that is, the end-to-end latency is above the threshold), the serial processing is too slow (the end-to-end latency is too high), and the parallelized processing should take over to ensure sufficient throughput to keep pace with the stream of observations. Where the threshold is not satisfied (that is, the end-to-end latency is below the threshold), the serial processing is sufficiently fast (the end-to-end latency is low enough) to allow for sufficient throughput. In this case, streaming ML estimation method 200 will continue to process the observations serially. Streaming ML estimation method 200 may occasionally re-check to determine whether a shift to parallelized processing is indicated by satisfying the threshold.

In one embodiment, the operations of streaming ML estimation method 200 are parallelized onto two compute instances, a primary compute instance for generating ML estimates, and an ancillary compute instance for handling streaming input and streaming output operations. In one embodiment, the primary and ancillary compute instances are virtual machines. In one embodiment, the primary and ancillary compute instances are instances of a containerized machine learning application. The primary and ancillary instances both have access to the first and second buffers.

Therefore, in one embodiment, the streaming ML estimation method 200 additionally instantiates a primary compute instance. The primary compute instance is configured to generate the estimates by the ML model. Streaming ML estimation method 200 also additionally instantiates an ancillary compute instance. The ancillary compute instance is configured to load the observations into the circular buffer and write the estimates to the stream of estimates. Streaming ML estimation method 200 places the circular buffer (including the first and second buffers) into a location(s) in memory that is accessible to both the primary compute instance and the ancillary compute instance. Additional detail regarding the compute instances is discussed above with reference to process block 220, and below for example with reference to FIG. 3.

An estimate at an index point (such as a time stamp) is generated from an observation for the index point. In this way, an estimate and observation correspond where an index point for the estimate is the index point for the observation. In one embodiment, when written to the stream of estimates an estimate is accompanied by the corresponding observation from which the estimate is generated. For example, an estimate may be generated by the ML model as a data structure including both the estimate and the observation for one time stamp. Where the observation is a vector that includes an observed value for each signal in a set of signals at a time stamp, the estimate may be a vector that includes both an observed value for each signal in a set of signals at the time stamp and an estimated value for each signal in the set of signals. Thus, in one embodiment, streaming ML estimation method 200 further writes the observations that correspond to the estimates to the stream of estimates along with the estimates.

The residuals or differences between the observations and estimates may be used to detect anomalies in the observations. In one embodiment, the ML model may generate the residuals by subtracting estimates from corresponding observations. An estimate, observation, and residual correspond where an index point for the residual is the index point for the observation and the estimate. In one embodiment, when written to the stream of estimates, an estimate is accompanied by the corresponding residual between the estimate and the corresponding observations from which the estimate is generated. For example, an estimate may be generated by the ML model as a data structure including both the estimate and the residuals for one time stamp. Where the estimate is a vector that includes an estimated value for each signal in a set of signals at the time stamp, the estimate may also include a residual value between estimated value and observed value for each signal in the set of signals at the time stamp. Thus, in one embodiment, streaming ML estimation method 200 further writes the residuals that correspond to the estimates to the stream of estimates along with the estimates.

As discussed above, with reference to process blocks 210 and 220, in one embodiment the observations and estimates are vectors that include values for multiple signals. And, in one embodiment, the machine learning model is a multivariate ML model that generates estimated values for each signal based on observed values of signals other than the one for which the estimated value is being generated. Thus, in one embodiment, the observations are vectors that include an observed value for each signal in a set of signals. And, the estimates are vectors that include an estimated value for each signal in the set of signals. And, the machine learning model is a multivariate machine learning model. Then, generating the estimates (as discussed at process block 220) further includes generating an estimated value for one signal in the set of signals based on observed values for signals in the set other than the one signal. An estimated value may be thus generated for each signal in the set from the observed values of other signals in the set.

As discussed herein, the ML model is used for detection of anomalies in the stream of observations based on the residuals between corresponding observations and estimates. An observed value in a signal is anomalous where the observed value deviates from an estimated values in a way that satisfies a threshold test for detection of an anomaly. In one embodiment, upon detection of an anomaly, an alert indicating the presence of an anomaly may be generated. In one embodiment, streaming ML estimation method 200 further generates an alert that an anomaly is detected in response to one or more residuals between one of the observations and one of the estimates for the one of the observations satisfying a threshold.

In one embodiment, to generate an alert, streaming ML estimation method 200 analyzes the residuals between the observations and estimates with the test for detection of an anomaly to determine whether the observations are anomalous. In one embodiment, the residuals may be parsed from the estimate data structures, where included in the estimate data structure as discussed above, or calculated from the estimates and observations. In one embodiment, the test for detection of an anomaly is the sequential probability ratio test (SPRT). The SPRT calculates a cumulative sum of the log-likelihood ratio for each successive residual between an observed value for a signal and an estimated value for the signal, and compares the cumulative sum against a threshold value indicating anomalous deviation. Where the threshold is crossed, an anomaly is detected.

In one embodiment, upon detection that one or more observed values in an observation are anomalous, an alert may be generated to inform users or other systems that there is an anomaly. In one embodiment, the alert is an electronic message. The alert may be generated by composing the electronic message, and then presented and transmitting the generated alert for subsequent display or other action. The alert may be configured to be displayed in a graphical user interface. For example, the alert may be used to inform an operator of a monitored asset that the asset is behaving abnormally or in an unexpected manner. The alert may be configured as a request (such as a REST request) used to trigger initiation of some other function. For example, the alert may be used to initiate an automatic adjustment or shut down of the operation of the monitored asset, or initiate an automatic maintenance request regarding the monitored asset. The alert may be generated and presented in real time following detection of the anomaly to enable rapid response to the detected anomaly.

In one embodiment, the batch size—which is the length of the first and second buffers—maybe provided to the streaming ML estimation method 200, and the lengths of the buffer adjusted to accommodate the batch size. The batch size (or buffer length) may be a value entered by the user. In one embodiment, the batch size is measured in a number of observation vectors or rows. In one embodiment, the batch size is a number of observation vectors that are to be stored in one buffer of the circular double buffer before becoming full and alternating to processing the buffer and storing vectors in the other buffer of the circular double buffer. In one embodiment, a user or administrator enters the buffer length into the system, for example in a user interface for configuring streaming ML estimation system 100. Once the buffer length is provided, streaming ML estimation method 200 configures the first buffer and second buffer to have a length—that is, number of available rows—that is the provided buffer length. Thus, in one embodiment, streaming ML estimation method 200 further accepts an input of a buffer length; and configures the first buffer and the second buffer to accept as many of the observations as the buffer length before becoming full.

In one embodiment, the batch size or buffer length can be automatically determined experimentally for a given use case. As used herein, the term “use case” refers to a particular configuration of rate of streaming and number of signals (number of observed values per observation). In one embodiment, a buffer length is automatically identified that causes streaming ML estimation method 200 to keep pace with the stream of observations when generating ML estimates for the number of signals. Thus, in one embodiment, streaming ML estimation method 200 further automatically identifies a buffer length; and configures the first buffer and the second buffer to accept as many of the observations as the buffer length before becoming full.

In one embodiment, to automatically identify the buffer length (batch size) for a use case, processing latency per batch for performing streaming ML estimation method 200 on a set of test data is repeatedly measured for differing batch sizes. The test data includes the number of signals for the use case. Observations from the test data are streamed to the streaming ML estimation system 100 at the rate of streaming for the use case. Where the total processing latency for a batch is less than the time taken to stream all observations for the batch, the processing can keep pace with the stream in real time. Thus, in one embodiment, the processor identifies those batch sizes for which the measured processing latency per batch is less than the time taken to stream all observations in the batch (streaming rate x batch size). In one embodiment, the measured processing latency per batch should be lower than the time taken to stream all observations in the batch by a margin, such as 20%, to allow for possible variation in processing latency.

In one embodiment, one of the identified batch sizes is automatically selected to be the buffer length. In one embodiment, the processor automatically selects the identified batch size for which the processing latency per batch is minimized. Note that processing latency is dominated by read and write latencies at smaller batch sizes, and by ML estimation latencies at larger batch sizes, as discussed below. Where the minimum processing latency per batch for the use case remains above the time taken to stream all observations in the batch, a faster compute configuration may be indicated. In one embodiment, the above process for automatic identification of batch size (buffer length) may be repeated for progressively faster compute configurations until a compute configuration and buffer length are determined to be able to keep pace with the streaming. Additional detail on identifying the batch size/buffer length is discussed herein below.

In one embodiment, the ML model is trained before being used to produce estimates. In one embodiment, the ML model is trained to generate estimates of what the observations are expected to be based on training observations that represent a normal operation. Additional detail on training the ML model is discussed above with reference to process block 220.

### —Additional Context and Embodiments—

Multivariate machine learning (ML) may be used for monitoring time-series signals for automated anomaly detection. Generally, ML anomaly detection services analyze data in static batches, for example, from previously recorded data historian databases. ML anomaly detection may be extended into real-time streaming mode, so that new time series streaming in from live sensors can be analyzed in real-time mode to detect anomalies (and actuate alarms) at the earliest possible time. In one example, ML anomaly detection may be extended into real-time streaming mode by performing looping batch processing (such as by repetitive calls to a ML function) to sequentially analyze batches (for example, frames or buffers) of customer data.

One challenge in converting static-batch style ML analyses is estimating in advance the throughput and latencies for large-scale ingestion and processing of data in a streaming mode. In one embodiment, a streaming mode should be configured to keep up with real time for a given number of signals and given sampling rate chosen for data to be monitored. Otherwise, where the throughput volume (that is, number of signals at sampling rate) of data reaches a point where the processing cannot keep up with real time, the system crashes and/or latencies build up in an unbounded manner. Either situation can cause time-out exceptions in an upstream data-ingestion hardware/software interface, or can even cause data to be discarded at the data-ingestion interface.

In analysis of ML anomaly detection algorithms, the challenge of estimating end-to-end real time processing latencies is complicated by the fact that ML compute cost grows non-linearly with the number of signals being monitored, but linearly with the product of sampling rate and buffer size for the data being analyzed. Moreover, there is a read latency component of processing delay for filling a buffer, and a write latency component of processing delay for writing results to an output stream.

Compare, for example, a simple throughput architecture (or “pipe”) for ML processing, a simple throughput architecture (or “pipe”) with processing time that is usually directly proportional, and a simple throughput architecture (or “pipe”) with no processing. In the throughput architecture for ML processing, incoming data streams fill a buffer for processing, when full the buffer is processed by the ML algorithm, then results are written to an output stream. In the simple throughput architecture with no processing there are no ML computations being performed when the buffer gets full, and the data is simply moved from input to output.

In the example simple throughput architecture with no processing, the estimation of end-to-end latency is trivial: there is a read latency to fill the buffer, and a write latency to output the buffer. If one moves the data through the pipe in large batches (for example, with a buffer length of 100,000 rows), the read & write latencies are modest. But, if the data moves through the pipe in small batches (for example, with a buffer length of 10 rows), then the read latency and write latency components can dominate the overall latency for sustained throughput of streaming time series. Nevertheless, for non-ML applications (where no batch computations are being done on the contents of the buffer), it is straightforward to estimate the overall streaming latencies. The cumulative latency is a simple linear function of the buffer length (or number of rows per chunk of data).

In the example simple throughput architecture for ML processing, where ML computations are being performed on the contents of the buffer, the end-to-end latency decomposition becomes significantly more challenging. For ML anomaly detection algorithms used on time series, the compute cost goes up quadratically with the number of signals in the buffer, and linearly with the number of rows in the buffer. This presents a complex, nonlinear tradeoff between the number of signals, the number of rows, buffer length, and compute shape (for example, various types of central processing units (CPUs) and graphics processing units (GPUs)), each of which can significantly alter the processing latency or time for when the ML is processing the contents of the buffer.

Thus, for ML anomaly detection techniques (such as the Multivariate State Estimation Technique (MSET), neural networks, and Support Vector Machines (SVMs)), the challenge of estimating end-to-end real time processing latencies is complicated by the fact that ML compute cost grows quadratically with the number of signals, but linearly with the product of sampling rate and buffer size for the data being analyzed. There is still a read latency component for filling the buffer, and a write latency for writing results to an output stream. But now to estimate the end-to-end throughput rates and cumulative latencies (to ensure that the streaming computations can keep up with the real time ingestion of times series data), becomes significantly more challenging. Moreover, determining end-to-end throughput latency of streaming ML anomaly detection techniques is not really amenable to brute force trial and error-such as by incrementing the number of signals and/or the sampling rates until the overall throughput can no longer keep up with real time-simply because a change to the number of signals or sampling rates for a new use case changes the choke point at which the streaming/processing architecture will not be able to keep up with incoming ingestion rates.

The processing time (or compute cost) for streaming data processing that is not associated with input and output can range from minimal, approximately 0 for just passing data through an I/O channel, to processing time that is directly proportional (and hence easily measurable and scalable) with the data volume, on to the complex, non-linear growth of ML anomaly detection processing. Examples of minimal, near zero processing costs include pass-through streaming of video, and data archiving from a streaming source to a storage system. Examples of linearly scalable processing costs include taking the square root of all the numbers passing through the pipe, data encryption/de-encryption, converting units for time series, statistically scaling the data, and language conversion. Prior art estimation of end-to-end latencies is straightforward for simple systems where there is no processing cost for the “data in motion”, and also for use cases where the processing cost scales linearly with the “volumetric throughput” of the data (in which case it is easy to measure the processing overhead for a small stream of data, and scale it linearly up to the bandwidth capacity for the architecture).

It is challenging to estimate end-to-end throughputs and latencies for time series data streams with ML anomaly detection processing, and particularly for multivariate pattern recognition. Examples of multivariate tools/techniques include the multivariate state estimation technique (MSET) (including Oracle's proprietary MSET2), neural networks (including long short-term memory (LSTM) networks), and Support Vector Machines (SVMs).

A challenge introduced by these multivariate anomaly detection techniques is that the compute cost (and hence processing latencies) vary nonlinearly with volume of the time series data. For example, the compute cost for a given buffer of data scales both quadratically with the number of signals in the buffer, and linearly with the number of rows in the buffer. Thus, for example, processing time for a buffer of time-series data with N columns of signals (from sensors) and M rows or vectors (timestamps) will be significantly different than processing time for a buffer of equal size that includes M columns and N rows (assuming that M is not equal to N).

Note that signals for anomaly detection use cases may involve a mixture of univariate and multivariate (meaning correlated) signals. A preprocessing step for anomaly detection identifies and separates the univariate signals from the multivariate signals for separate processing. That preprocessing analysis is a one-time upstream and offline analysis, and hence is not part of estimating throughputs and latencies for streaming multivariate ML anomaly detection.

In one embodiment, two processing modes for multivariate ML anomaly detection are introduced herein. A first processing mode uses a single circular-buffer for multivariate ML anomaly detection on streaming signals. A second processing mode uses a circular-double-buffer for multivariate ML anomaly detection on streaming signals. Each approach may be used, for example in a cloud implementation, cloud-edge, or local-server implementation of multivariate ML anomaly detection on streaming signals.

In general, in multivariate ML time-series analysis the computations operate on a buffer of data. In one embodiment, the buffer of data is an array of time series numbers. In the array of time series numbers, the columns represent the sensors, and the rows represent the time stamps or observations (although an opposite convention in which columns represent time stamps and rows represent sensors might also be used). An example might be signals from an asset with 30 sensors, and 1000 timestamped observations at a time would be loaded into a buffer with 30 columns and 1000 rows. Continuous buffering of streaming data is generally utilized to deal with streaming data.

In one embodiment, the buffers are circular buffers. Circular buffers are configured to temporarily store streaming data. In a circular buffer, the buffer is configured to be filled with new, incoming data, and to be emptied as results are written out after ML anomaly detection analysis is completed. The buffer length (number of rows) stays the same with each application of the ML algorithm. In the simple example above with 1000 rows, the circular buffer is filled with an incoming stream of 1000 rows of data ingested, the 1000 rows of data are analyzed by the ML algorithm to identify residuals between observed and estimated values, then 1000 rows of results (corresponding to the 1000 rows of data) are written to an output stream.

In single-circular-buffer streaming throughput processing, read, ML analysis, and write processing occur in linear order for each batch of data. There is a “read latency” at the beginning of the operation, which is time taken to fill the buffer. The read latency grows in a linear manner with increase in the volume (number of signals multiplied by sampling rate) of the buffer. There is an ML analysis latency, which is time taken for the ML analysis of the contents of the buffer. The ML analysis latency scales nonlinearly with the volume of data in the buffer. In particular, the ML analysis latency scales quadratically with the number of signals (columns) but linearly with the number of vectors of observations (rows). There is a write latency, which is time taken for writing the results to an output stream. Like the read latency, the write latency is also linear with the volume of data in the buffer. The write latency may be larger than the read latency because the output results can have more columns than the input stream. For example, ML analyses output the original raw time series signals as well as the computed results for those signals, meaning the output streams have twice the number of columns as the input streams. But, the output write latency is still linearly proportional to the volume of data in the buffer.

Note that for a given use case (where the number of sensors is fixed and unchangeable) there can be a significantly different overall throughput latency depending on the buffer length (that is, number of rows per buffer) chosen when using a single-buffer configuration. Depending on the length (in rows) of the circular buffer chosen for the batches to be processed by the ML, when there is a singular circular buffer, decomposing the latencies involves three important components: read latency (which is proportional to the number of signals multiplied by the number of input rows), processing (ML analysis) Latency (which scales with the number of signals squared multiplied by the number of input rows), and write latency (which is proportional to the number of signals multiplied by the number of output rows). For any given use case, there can be a wide range of end-to-end latencies depending in a nontrivial way to circular buffer length. Circular buffer length may be user configurable. End-to-end latency may be accurately assessed parametrically as a function of window width (number of rows) in a single-buffer framework for ML anomaly detection in streaming data.

It is possible that ML analysis of large-scale sensor groups in real time may challenge or be beyond the capability of available computer processing specifications. Note that at the time of writing, an individual commercial aircraft may have over 75,000 sensors, a modern oil refinery or a moderately-sized data center may each have over 1,000,000 sensors. A circular-double-buffer, alternating-pointer framework for ML anomaly detection in streaming data is presented herein as an alternative to use of a single-buffer framework in use cases where end-to-end throughput latencies exceed maximum latency requirements for large-scale real time processing applications. The circular-double-buffer approach hides the latencies for all (or nearly all) of the read/write latencies, as discussed in further detail elsewhere herein.

Latency in a typical streaming application with the single circular-buffer approach is characterized by three latency components for each buffer of data: read time, processing (ML analysis) time, and write time. So, with sequential single-buffer processing, after B buffers, the total end-to-end latency L would B buffers times read latency L_{R}, processing latency L_{P}, and write latency L (L_{T}=B×(L_{R}+L_{P}+L_{W})). The total latency is linearly proportional to the buffer size, or the dimensions of the buffer in number of measurements (rows) and signals. But, processing latency L_{P} increases quadratically as the number of signals in the buffer that are processed by the ML model goes up.

Note that the three latency components apply generally to ML anomaly detection techniques, including MSET, neural networks, and SVMs. Hyperparameters specific to the ML techniques (such as the numvecs (number of vectors) hyperparameter in MSET2) are not relevant to latency. Thus, in one embodiment, the latency calculations and the circular-double-buffer streaming shown and described herein is compatible with any ML techniques.

As an alternative to the single buffer approach in which the read and write latencies stack cumulatively with the processing latency for ML anomaly detection, the circular double buffer approach hides the read and write latencies and thereby maximizes the content of each buffer. In one embodiment, two compute instances are initiated for the circular double buffer approach, so each compute instance has a dedicated buffer. The two dedicated buffers are each accessible by both compute instances. The two dedicated buffers may be configured together end-to-end in a circular configuration to form the circular double buffer.

In one embodiment, under the circular double buffer approach, an intake pointer and outflow pointer both alternate between the two dedicated buffers. The intake pointer indicates which of the two dedicated buffers that make up the circular double buffer is currently being loaded with incoming observations, for example by an ancillary instance. The outflow pointer indicates which of the two dedicated buffers is currently being read by the ML model. The intake and outflow pointers indicate opposite buffers of the two dedicated buffers that make up the circular double buffer. While a primary instance is doing computation, an ancillary instance is loading the next batch of data.

With this approach, for the same B batches of data in the previous example, there is only one read latency L_{R}, plus B processing latency L_{P}, plus one write latency L_{W}(L_{T}=L_{R}+(B×L_{P})+L_{W}). Hence, B occurrences of combined read latency and write latency are cut out of the total end-to-end latency. The circular-double-buffer, alternating-pointer approach thus hides the latency for the read and write operations by performing the read and write operations in parallel by an ancillary compute instance. Additional detail on the operation of the circular-double-buffer approach using the alternating pointers is shown herein with reference to FIG. 3.

FIG. 3 illustrates a range chart of single-buffer operations 300 and a range chart of circular-double-buffer operations 305 using alternating pointers to switch between buffers. Range charts 300 and 305 show latency decomposed into components and allocated among compute instances. Range chart of single-buffer operations 300 shows an order of performing read, processing, and write operations in the single-buffer configuration using one compute instance 310. Range chart of circular-double-buffer operations 305 shows an order of performing read, processing, and write operations in the circular-double-buffer configuration using a primary compute instance 315 and an ancillary compute instance 320. The read, processing, and write operations are shown alongside an axis of compute time 325. Read blocks (shown with diagonal hashing) take approximately a first amount of compute time to complete. Processing blocks (shown without hashing) take approximately a second amount of compute time to complete. Write blocks (shown with cross-hatching) take approximately a third amount of compute time to complete.

In the single-buffer configuration using one compute instance 310, the one compute instance 310 reads the first batch of data at read block 330, adding the first amount of compute time to the end-to-end latency. Then, the one compute instance 310 processes the first batch of data to produce ML estimates for the first batch at processing block 331, adding the second amount of compute time to the end-to-end latency. Then, the one compute instance 310 writes the ML estimates for the first batch of data to an output stream at write block 332, adding the third amount of compute time to the end-to-end latency. Then, the process repeats for the second and subsequent batches of data. For example, the first amount of compute time is added again to the end-to-end latency by the one compute instance 310 reading the second batch at read block 333. The second amount of compute time is added again to the end-to-end latency by the one compute instance 310 processing the ML estimates for the second batch at processing block 334. And, the third amount of compute time is added again to the end-to-end latency by the one compute instance 310 writing the estimates to the stream at write block 335.

In the circular-double-buffer configuration using primary compute instance 315 and ancillary compute instance 320, the ancillary compute instance 320 reads the first batch of data at read block 340, adding the first amount of compute time to the end-to-end latency. Then, the primary compute instance 315 processes the first batch of data to produce ML estimates for the first batch at processing block 341, adding the second amount of compute time to the end-to-end latency. While the primary compute instance 315 is producing ML estimates at processing block 341, ancillary compute instance 320 is reading the second batch of data at read block 342. Although read block 342 consumes the first amount of compute time, the first amount of compute time for read block 342 is not added to the end-to-end latency because read block 342 is performed simultaneously by ancillary compute instance 320 while primary compute instance 315 is performing processing block 341.

The second batch has been loaded by ancillary compute instance 320 by the time primary compute instance 315 has completed making estimates for the first batch. Primary compute instance 315 then processes the second batch of data to produce ML estimates at processing block 343, adding the second amount of compute time to the end-to-end latency. While the primary compute instance 315 is producing ML estimates for the second batch at processing block 343, ancillary compute instance 320 is (i) writing the estimates for the first batch of data to the output stream at write block 344 and (ii) reading the third batch of data at read block 345. Although read block 345 consumes the first amount of compute time, and write block 344 consumes the third amount of compute time, the first and third amounts of compute time for read block 345 and write block 344 are not added to the end-to-end latency because these read and write blocks are performed by ancillary compute instance 320 while primary compute instance 315 is producing estimates for the second batch at block 343.

In one embodiment, the read and write operations performed by ancillary compute instance 320 may be intermingled, although shown as discrete blocks in chart of circular-double-buffer operations 305. In one embodiment, the write operations for a batch are not delayed until after a batch of ML estimates is processed, although shown as subsequent to processing of batches in chart of circular-double-buffer operations 305. For example, as discussed above, individual estimates are written to the stream of estimates by ancillary compute instance 320 promptly upon generation by primary compute instance 315. Thus, some individual estimates from a batch may be written to the stream of estimates contemporaneously with generation of other estimates in the batch.

The process continues in a similar manner through subsequent batches of data. For example, ancillary compute instance 320 reads a subsequent batch of data and writes estimates while primary compute instance 315 generates ML estimates for a current batch of data. This adds only the second amount of compute time to the end-to-end latency for each batch until after the final batch. After the estimates are generated for a final batch of data, a final write operation for the final batch is performed by ancillary compute instance 320, adding the third amount of compute time to the end-to-end latency.

FIG. 4 shows an example graph 400 of total latency vs. number of signals 405 for streaming ML anomaly detection with a single buffer processing configuration. Total latency vs. number of signals 405 is plotted against a first axis 410 showing number of signals in a buffer and a second axis 415 showing total latency of streaming ML anomaly detection. Note that the line for the total latency vs. number of signals 405 is not smooth, due to the somewhat random amount of time required by read, write, and load operations that are cumulative with the time taken for ML anomaly detection.

To showcase the improved latency after the circular-double-buffer approach is adopted, the streaming use case presented in FIG. 4 for the single-buffer approach is re-run with the circular-double-buffer approach, as shown in FIG. 5. Note that when measuring the latency, only the total end-to-end latency incurred is measured, since an objective is to minimize total, end-to-end latency.

FIG. 5 shows an example graph 500 of total latency vs. number of signals 505 for streaming ML anomaly detection with a circular-double-buffer processing configuration. Total latency vs. number of signals 505 is plotted against a first axis 510 showing number of signals in a buffer and a second axis 515 showing total latency of streaming ML anomaly detection. As seen when comparing FIG. 4 and FIG. 5, the total latency is an order of magnitude smaller. For example, the total latency is reduced by about 90%. Also, the line for total latency vs. number of signals 505 using the circular-double-buffer processing configuration is smoother than the line for total latency vs. number of signals 405 using the single buffer configuration. The line for total latency vs. number of signals 505 is smoother because the random-time read, write, and load operations are not performed in-line with the ML anomaly detection processing. For example, in one embodiment, the read, write, and load operations are not performed by a first compute instance that also performs the ML anomaly detection processing. Instead, these prominent buffer loads are hidden away. For example, in one embodiment, the read, write, and load operations are performed instead by a second compute instance that is not performing the ML anomaly detection processing.

Although shifting from a processing loop with a single circular buffer to a processing loop with a circular-double-buffer as described herein substantially reduces end-to-end latency for streaming ML anomaly detection, there is generally no further reduction in latency to be gained by adding still more buffers. The reason, as discussed above with reference to FIG. 3, is that a significant speedup in going from single-buffer processing to circular-double-buffer processing comes from parallelizing read and write latencies for filling and discharging buffers with the processing latencies for generating ML estimates using the circular double buffer. Once the latencies are thus hidden by changing from a single buffer to circular double buffer in the processing loop, no further gains would be achieved by going to 3, 4, . . . N circular buffers where the combined read latency and write latency is less than the processing latency (as is generally the case). An additional buffer may yield a further reduction in processing latency where the combined read latency and write latency is longer than the processing latency, but as a practical matter, the combined read latency and write latency is generally less than the processing latency.

### —Some Selected Advantages—

In one embodiment, the systems and methods described herein present a circular-double-buffer configuration for multivariate anomaly detection on a real time stream of values. In one embodiment, the circular-double-buffer configuration hides the read/write latencies and achieves greater throughputs and lower end-to-end computational latencies than is achievable by a single-buffer configuration.

In one embodiment, the systems and methods described herein enable conversion of batch-wise multivariate ML anomaly detection into a real-time streaming architecture.

In one example, an accurate framework for separating and analyzing the component contributors to end-to end latency in both single-circular-buffer ML processing and circular-double-buffer ML processing is presented herein.

### —Cloud or Enterprise Embodiments—

In one embodiment, the present system (such as streaming ML estimation system 100) is a computing/data processing system including a computing application or collection of distributed computing applications for access and use by other client computing devices that communicate with the present system over a network. In one embodiment, streaming ML estimation system 100 is a component of a time series data service that is configured to gather, serve, and execute operations on time series data. The applications and computing system may be configured to operate with or be implemented as a cloud-based network computing system, an infrastructure-as-a-service (IAAS), platform-as-a-service (PAAS), or software-as-a-service (SAAS) architecture, or other type of networked computing solution. In one embodiment the present system provides at least one or more of the functions disclosed herein and a graphical user interface to access and operate the functions. In one embodiment streaming ML estimation system 100 is a centralized server-side application that provides at least the functions disclosed herein and that is accessed by many users by way of computing devices/terminals communicating with the computers of streaming ML estimation system 100 (functioning as one or more servers) over a computer network. In one embodiment streaming ML estimation system 100 may be implemented by a server or other computing device configured with hardware and software to implement the functions and features described herein.

In one embodiment, the components of streaming ML estimation system 100 may be implemented as sets of one or more software modules executed by one or more computing devices specially configured for such execution. In one embodiment, the components of streaming ML estimation system 100 are implemented on one or more hardware computing devices or hosts interconnected by a data network. For example, the components of streaming ML estimation system 100 may be executed by network-connected computing devices of one or more compute hardware shapes, such as central processing unit (CPU) or general-purpose shapes, dense input/output (I/O) shapes, graphics processing unit (GPU) shapes, and high-performance computing (HPC) shapes.

In one embodiment, the components of streaming ML estimation system 100 intercommunicate by electronic messages or signals. These electronic messages or signals may be configured as calls to functions or procedures that access the features or data of the component, such as for example application programming interface (API) calls. In one embodiment, these electronic messages or signals are sent between hosts in a format compatible with transmission control protocol/internet protocol (TCP/IP) or other computer networking protocol. Components of streaming ML estimation system 100 may (i) generate or compose an electronic message or signal to issue a command or request to another component, (ii) transmit the message or signal to other components of streaming ML estimation system 100, (iii) parse the content of an electronic message or signal received to identify commands or requests that the component can perform, and (iv) in response to identifying the command or request, automatically perform or execute the command or request. The electronic messages or signals may include queries against databases. The queries may be composed and executed in query languages compatible with the database and executed in a runtime environment compatible with the query language.

In one embodiment, remote computing systems may access information or applications provided by streaming ML estimation system 100, for example through a web interface server. In one embodiment, the remote computing system may send requests to and receive responses from streaming ML estimation system 100. In one example, access to the information or applications may be effected through use of a web browser on a personal computer or mobile device. In one example, communications exchanged with streaming ML estimation system 100 may take the form of remote representational state transfer (REST) requests using JavaScript object notation (JSON) as the data interchange format for example, or simple object access protocol (SOAP) requests to and from XML servers. The REST or SOAP requests may include API calls to components of streaming ML estimation system 100.

### —Software Module Embodiments—

In general, software instructions are designed to be executed by one or more suitably programmed processors accessing memory. These software instructions may include, for example, computer-executable code and source code that may be compiled into computer-executable code. These software instructions may also include instructions written in an interpreted programming language, such as a scripting language.

In a complex system, such instructions may be arranged into program modules with each such module performing a specific task, process, function, or operation. The entire set of modules may be controlled or coordinated in their operation by an operating system (OS) or other form of organizational platform.

In one embodiment, one or more of the components described herein are configured as modules stored in a non-transitory computer readable medium. The modules are configured with stored software instructions that when executed by at least a processor accessing memory or storage cause the computing device to perform the corresponding function(s) as described herein.

### —Computing Device Embodiment—

FIG. 6 illustrates an example computing system 600 including an example computing device that is configured and/or programmed as a special purpose computing device with one or more of the example systems and methods described herein, and/or equivalents. The example computing device may be a computer 605 that includes at least one hardware processor 610, a memory 615, and input/output ports 620 operably connected by a bus 625. In one example, the computer 605 may include streaming ML estimation logic 630 configured to facilitate generating a stream of ML estimates from a stream of observations in real-time using a circular double buffer, similar to logic, systems, and methods shown and described with reference to FIGS. 1, 2, 3, 4 and 5.

In different examples, the logic 630 may be implemented in hardware, a non-transitory computer-readable medium 637 with stored instructions, firmware, and/or combinations thereof. While the logic 630 is illustrated as a hardware component attached to the bus 625, it is to be appreciated that in other embodiments, the logic 630 could be implemented in the processor 610, stored in memory 615, or stored in disk 635.

In one embodiment, logic 630 or the computer is a means (e.g., structure: hardware, non-transitory computer-readable medium, firmware) for performing the actions described. In some embodiments, the computing device may be a server operating in a cloud computing system, a server configured in a Software as a Service (SaaS) architecture, a smart phone, laptop, tablet computing device, and so on.

The means may be implemented, for example, as an ASIC programmed to facilitate generating a stream of ML estimates from a stream of observations in real-time using a circular double buffer. The means may also be implemented as stored computer executable instructions that are presented to computer 605 as data 640 that are temporarily stored in memory 615 and then executed by processor 610.

Logic 630 may also provide means (e.g., hardware, non-transitory computer-readable medium that stores executable instructions, firmware) for generating a stream of ML estimates from a stream of observations in real-time using a circular double buffer.

Generally describing an example configuration of the computer 605, the processor 610 may be a variety of various processors including dual microprocessor and other multi-processor architectures. A memory 615 may include volatile memory and/or non-volatile memory. Non-volatile memory may include, for example, ROM, PROM, and so on. Volatile memory may include, for example, RAM, SRAM, DRAM, and so on.

A storage disk 635 may be operably connected to the computer 605 via, for example, an input/output (I/O) interface (e.g., card, device) 645 and an input/output port 620 that are controlled by at least an input/output (I/O) controller 647. The disk 635 may be, for example, a magnetic disk drive, a solid-state disk drive, a floppy disk drive, a tape drive, a Zip drive, a flash memory card, a memory stick, and so on. Furthermore, the disk 635 may be a CD-ROM drive, a CD-R drive, a CD-RW drive, a DVD ROM, and so on. The memory 615 can store a process 650 and/or a data 640, for example. The disk 635 and/or the memory 615 can store an operating system that controls and allocates resources of the computer 605.

The computer 605 may interact with, control, and/or be controlled by input/output (I/O) devices via the input/output (I/O) controller 647, the I/O interfaces 645, and the input/output ports 620. Input/output devices may include, for example, one or more displays 670, printers 672 (such as inkjet, laser, or 3D printers), audio output devices 674 (such as speakers or headphones), text input devices 680 (such as keyboards), cursor control devices 682 for pointing and selection inputs (such as mice, trackballs, touch screens, joysticks, pointing sticks, electronic styluses, electronic pen tablets), audio input devices 684 (such as microphones or external audio players), video input devices 686 (such as video and still cameras, or external video players), image scanners 688, video cards (not shown), disks 635, network devices 655, and so on. The input/output ports 620 may include, for example, serial ports, parallel ports, and USB ports.

The computer 605 can operate in a network environment and thus may be connected to the network devices 655 via the I/O interfaces 645, and/or the I/O ports 620. Through the network devices 655, the computer 605 may interact with a network 655. Through the network, the computer 605 may be logically connected to remote computers 665. Networks with which the computer 605 may interact include, but are not limited to, a LAN, a WAN, and other networks.

In one embodiment, the computer may be connected to sensors 690 through I/O ports 620 or networks 660 in order to receive information about physical states of monitored machines, devices, systems, or facilities (collectively referred to as “assets”). In one embodiment, sensors 690 are configured to monitor physical phenomena occurring in or around an asset. The assets generally include any type of machinery or facility with components that perform measurable activities. In one embodiment, sensors 690 may be operably connected or affixed to assets or otherwise configured to detect and monitor physical phenomena occurring in or around the asset. The sensors 690 may be network-connected sensors for monitoring any type of physical phenomena. The network connection of the sensors 690 and networks 660 may be wired or wireless.

In one embodiment, computer 605 is configured with logic, such as software modules, to collect readings from sensors 690 and store them as observations in a time series data structure such as a time series database. In one embodiment, the computer 605 passively receives sensor telemetry readings actively transmitted by sensors 690. For example, the sensor telemetry readings may be transmitted in a real time stream to the computer 605 from the sensors 690. In one embodiment, the time series database is stored in a buffer, as discussed above. In one embodiment, the computer 605 polls sensors 690 to retrieve sensor telemetry readings. In one embodiment, the computer 605 receives one or more databases of previously collected observations of sensors 690, for example from storage 635 or from remote computers 665.

### —Definitions and Other Embodiments—

No action or function described or claimed herein is performed by the human mind. An interpretation that any action or function can be performed in the human mind is inconsistent with and contrary to this disclosure.

In another embodiment, the described methods and/or their equivalents may be implemented with computer executable instructions. Thus, in one embodiment, a non-transitory computer readable/storage medium is configured with stored computer executable instructions of an algorithm/executable application that when executed by a machine(s) cause the machine(s) (and/or associated components) to perform the method. Example machines include but are not limited to a processor, a computer, a server operating in a cloud computing system, a server configured in a Software as a Service (SaaS) architecture, a smart phone, and so on). In one embodiment, a computing device is implemented with one or more executable algorithms that are configured to perform any of the disclosed methods.

In one or more embodiments, the disclosed methods or their equivalents are performed by either: computer hardware configured to perform the method; or computer instructions embodied in a module stored in a non-transitory computer-readable medium where the instructions are configured as an executable algorithm configured to perform the method when executed by at least a processor of a computing device.

While for purposes of simplicity of explanation, the illustrated methodologies in the figures are shown and described as a series of blocks of an algorithm, it is to be appreciated that the methodologies are not limited by the order of the blocks. Some blocks can occur in different orders and/or concurrently with other blocks from that shown and described. Moreover, less than all the illustrated blocks may be used to implement an example methodology. Blocks may be combined or separated into multiple actions/components. Furthermore, additional and/or alternative methodologies can employ additional actions that are not illustrated in blocks. The methods described herein are limited to statutory subject matter under 35 U.S.C § 101.

The following includes definitions of selected terms employed herein. The definitions include various examples and/or forms of components that fall within the scope of a term and that may be used for implementation. The examples are not intended to be limiting. Both singular and plural forms of terms may be within the definitions.

References to “one embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element, or limitation. Furthermore, repeated use of the phrase “in one embodiment” does not necessarily refer to the same embodiment, though it may.

A “data structure”, as used herein, is an organization of data in a computing system that is stored in a memory, a storage device, or other computerized system. A data structure may be any one of, for example, a data field, a data file, a data array, a data record, a database, a data table, a graph, a tree, a linked list, and so on. A data structure may be formed from and contain many other data structures (e.g., a database includes many data records). Other examples of data structures are possible as well, in accordance with other embodiments.

“Computer-readable medium” or “computer storage medium”, as used herein, refers to a non-transitory medium that stores instructions and/or data configured to perform one or more of the disclosed functions when executed. Data may function as instructions in some embodiments. A computer-readable medium may take forms, including, but not limited to, non-volatile media, and volatile media. Non-volatile media may include, for example, optical disks, magnetic disks, and so on. Volatile media may include, for example, semiconductor memories, dynamic memory, and so on. Common forms of a computer-readable medium may include, but are not limited to, a floppy disk, a flexible disk, a hard disk, a magnetic tape, other magnetic medium, an application specific integrated circuit (ASIC), a programmable logic device, a compact disk (CD), other optical medium, a random access memory (RAM), a read only memory (ROM), a memory chip or card, a memory stick, solid state storage device (SSD), flash drive, and other media from which a computer, a processor or other electronic device can function with. Each type of media, if selected for implementation in one embodiment, may include stored instructions of an algorithm configured to perform one or more of the disclosed and/or claimed functions. Computer-readable media described herein are limited to statutory subject matter under 35 U.S.C § 101.

“Logic”, as used herein, represents a component that is implemented with computer or electrical hardware, a non-transitory medium with stored instructions of an executable application or program module, and/or combinations of these to perform any of the functions or actions as disclosed herein, and/or to cause a function or action from another logic, method, and/or system to be performed as disclosed herein. Equivalent logic may include firmware, a microprocessor programmed with an algorithm, a discrete logic (e.g., ASIC), at least one circuit, an analog circuit, a digital circuit, a programmed logic device, a memory device containing instructions of an algorithm, and so on, any of which may be configured to perform one or more of the disclosed functions. In one embodiment, logic may include one or more gates, combinations of gates, or other circuit components configured to perform one or more of the disclosed functions. Where multiple logics are described, it may be possible to incorporate the multiple logics into one logic. Similarly, where a single logic is described, it may be possible to distribute that single logic between multiple logics. In one embodiment, one or more of these logics are corresponding structure associated with performing the disclosed and/or claimed functions. Choice of which type of logic to implement may be based on desired system conditions or specifications. For example, if greater speed is a consideration, then hardware would be selected to implement functions. If a lower cost is a consideration, then stored instructions/executable application would be selected to implement the functions. Logic is limited to statutory subject matter under 35 U.S.C. § 101.

An “operable connection”, or a connection by which entities are “operably connected”, is one in which signals, physical communications, and/or logical communications may be sent and/or received. An operable connection may include a physical interface, an electrical interface, and/or a data interface. An operable connection may include differing combinations of interfaces and/or connections sufficient to allow operable control. For example, two entities can be operably connected to communicate signals to each other directly or through one or more intermediate entities (e.g., processor, operating system, logic, non-transitory computer-readable medium). Logical and/or physical communication channels can be used to create an operable connection.

“User”, as used herein, includes but is not limited to one or more persons, computers or other devices, or combinations of these.

While the disclosed embodiments have been illustrated and described in considerable detail, it is not the intention to restrict or in any way limit the scope of the appended claims to such detail. It is, of course, not possible to describe every conceivable combination of components or methodologies for purposes of describing the various aspects of the subject matter. Therefore, the disclosure is not limited to the specific details or the illustrative examples shown and described. Thus, this disclosure is intended to embrace alterations, modifications, and variations that fall within the scope of the appended claims, which satisfy the statutory subject matter requirements of 35 U.S.C. § 101.

To the extent that the term “includes” or “including” is employed in the detailed description or the claims, it is intended to be inclusive in a manner similar to the term “comprising” as that term is interpreted when employed as a transitional word in a claim.

To the extent that the term “or” is used in the detailed description or claims (e.g., A or B) it is intended to mean “A or B or both”. When the applicants intend to indicate “only A or B but not both” then the phrase “only A or B but not both” will be used. Thus, use of the term “or” herein is the inclusive, and not the exclusive use.

What is claimed is:

1. A non-transitory computer-readable medium that includes stored thereon computer-executable instructions for generating a stream of estimates from a stream of observations in real time that when executed by at least a processor of a computer cause the computer to:
receive observations from the stream of observations;
load the observations in real time into a circular buffer, wherein the circular buffer includes a first buffer and a second buffer that are configured together in a circular configuration;
generate estimates by a machine learning model of what the observations are expected to be from the observations that are in the circular buffer, wherein the generation of estimates alternates between generating the estimates from the observations that are in the first buffer in parallel while the second buffer is being loaded, and generating the estimates from the observations that are in the second buffer in parallel while the first buffer is being loaded; and
write the estimates to the stream of estimates in real time as the estimates are generated.

2. The non-transitory computer-readable medium of claim 1, further comprising instructions that when executed by at least the processor cause the processor to generate an alert that an anomaly is detected in response to one or more residuals between one of the observations and one of the estimates for the one of the observations satisfying a threshold.

3. The non-transitory computer-readable medium of claim 1, further comprising instructions that when executed by at least the processor cause the processor to:
measure an end-to-end latency for serially loading the observations, generating the estimates from the observations, and writing the estimates to the stream of estimates;
compare the end-to-end latency to a threshold for a maximum acceptable latency, and
switch to loading the observations into the circular buffer in response to satisfying the threshold.

4. The non-transitory computer-readable medium of claim 1, further comprising instructions that when executed by at least the processor cause the processor to:
instantiate a primary compute instance, wherein the primary compute instance is configured to generate the estimates by the ML model;
instantiate an ancillary compute instance, wherein the ancillary compute instance is configured to load the observations into the circular buffer and write the estimates to the stream of estimates; and
place the circular buffer into a location in memory accessible to both the primary compute instance and the ancillary compute instance.

5. The non-transitory computer-readable medium of claim 1, further comprising instructions that when executed by at least the processor cause the processor to write the observations that correspond to the estimates to the stream of estimates along with the estimates.

6. The non-transitory computer-readable medium of claim 1,
wherein the observations are vectors that include an observed value for each signal in a set of signals,
wherein the estimates are vectors that include an estimated value for each signal in the set of signals,
wherein the machine learning model is a multivariate machine learning model, and
wherein the instructions to generate the estimates further comprise instructions that when executed by at least the processor cause the processor to generate an estimated value for one signal in the set of signals based on observed values for signals in the set other than the one signal.

7. The non-transitory computer-readable medium of claim 1, further comprising training the machine learning model to generate estimates of what the observations are expected to be based on training observations that represent a normal operation.

8. A computer-implemented method for generating a stream of estimates from a stream of observations in real time, the method comprising:
receiving observations from the stream of observations;
loading the observations in real time into a circular buffer, wherein the circular buffer includes a first buffer and a second buffer that are configured together in a circular configuration;
generating estimates by a machine learning model of what the observations are expected to be from the observations that are in the circular buffer, wherein the generation of estimates alternates between generating the estimates from the observations that are in the first buffer in parallel while the second buffer is being loaded, and generating the estimates from the observations that are in the second buffer in parallel while the first buffer is being loaded; and
writing the estimates to the stream of estimates in real time as the estimates are generated.

9. The computer-implemented method of claim 8, further comprising generating an alert that an anomaly is detected in response to one or more residuals between one of the observations and one of the estimates for the one of the observations satisfying a threshold.

10. The computer-implemented method of claim 8, further comprising:
measuring an end-to-end latency for serially loading the observations, generating the estimates from the observations, and writing the estimates to the stream of estimates;
comparing the end-to-end latency to a threshold for a maximum acceptable latency, and
switching to loading the observations into the circular buffer in response to satisfying the threshold.

11. The computer-implemented method of claim 8, further comprising:
instantiating a primary compute instance, wherein the primary compute instance is configured to generate the estimates by the ML model;
instantiating an ancillary compute instance, wherein the ancillary compute instance is configured to load the observations into the circular buffer and write the estimates to the stream of estimates; and
placing the circular buffer into a location in memory accessible to both the primary compute instance and the ancillary compute instance.

12. The computer-implemented method of claim 8, further comprising:
writing the observations that correspond to the estimates to the stream of estimates along with the estimates; and
writing the residuals that correspond to the estimates to the stream of estimates along with the estimates.

13. The computer-implemented method of claim 8,
wherein the observations are vectors that include an observed value for each signal in a set of signals,
wherein the estimates are vectors that include an estimated value for each signal in the set of signals,
wherein the machine learning model is a multivariate machine learning model, and
wherein generating the estimates further comprises generating an estimated value for one signal in the set of signals based on observed values for signals in the set other than the one signal.

14. The computer-implemented method of claim 8, further comprising:
accepting an input of a buffer length; and
configuring the first buffer and the second buffer to accept as many of the observations as the buffer length before becoming full.

15. A computing system, comprising:
at least one processor connected to at least one memory;
a non-transitory computer-readable medium including instructions stored thereon for generating a stream of estimates from a stream of observations in real time that when executed by at least the processor cause the computing system to:
receive observations from the stream of observations;
load the observations in real time into a circular buffer, wherein the circular buffer includes a first buffer and a second buffer that are configured together in a circular configuration;
generate estimates by a machine learning model of what the observations are expected to be from the observations that are in the circular buffer, wherein the generation of estimates alternates between generating the estimates from the observations that are in the first buffer in parallel while the second buffer is being loaded, and generating the estimates from the observations that are in the second buffer in parallel while the first buffer is being loaded; and
write the estimates to the stream of estimates in real time as the estimates are generated.

16. The computing system of claim 15, wherein the instructions further cause the computing system to generate an alert that an anomaly is detected in response to one or more residuals between one of the observations and one of the estimates for the one of the observations satisfying a threshold.

17. The computing system of claim 15, wherein the instructions further cause the computing system to:
measure an end-to-end latency for serially loading the observations, generating the estimates from the observations, and writing the estimates to the stream of estimates;
compare the end-to-end latency to a threshold for a maximum acceptable latency, and
switch to loading the observations into the circular buffer in response to satisfying the threshold.

18. The computing system of claim 15, wherein the instructions further cause the computing system to:
instantiate a primary compute instance, wherein the primary compute instance is configured to generate the estimates by the ML model;
instantiate an ancillary compute instance, wherein the ancillary compute instance is configured to load the observations into the circular buffer and write the estimates to the stream of estimates; and
place the circular buffer into a location in memory accessible to both the primary compute instance and the ancillary compute instance.

19. The computing system of claim 15, wherein the instructions further cause the computing system to write the residuals that correspond to the estimates to the stream of estimates along with the estimates.

20. The computing system of claim 15, wherein the instructions further cause the computing system to:
automatically identify a buffer length; and
configure the first buffer and the second buffer to accept as many of the observations as the buffer length before becoming full.
